(19) United States
(12) Patent Application Publication
(10) Pub. No.: US 2015/0017321 A1
(43) Pub. Date: Jan. 15, 2015

(54) METHOD FOR FORMING THIN FILM PATTERN

(71) Applicant: V TECHNOLOGY CO., LTD., Yokohama-shi (JP)

(72) Inventors: Syuji KUDO, Yokohama-shi (JP); Michinobu MIZUMURA, Yokohama-shi (JP); Koichi KAJIYAMA, Yokohama-shi (JP); Hany Maher AZIZ, Oakville (CA); Yoshitaka KAJIYAMA, Waterloo (CA)

(21) Appl. No.: 14/500,767

(22) Filed: Sep. 29, 2014

Related U.S. Application Data
(63) Continuation of application No. PCT/JP2013/058543, filed on Mar. 25, 2013.

(30) Foreign Application Priority Data
Mar. 30, 2012 (JP) 2012-079207
Dec. 3, 2012 (JP) 2012-264451

(51) Int. Cl. H01M 4/00

(52) U.S. Cl. CPC H01M 4/00
USPC 427/77; 264/400

(57) ABSTRACT

To provide a method for forming a thin film pattern 14 having a predetermined shape on a surface of a substrate 1 having an electrode formed in advance in a thin film pattern forming region, there are included the steps of: bringing a resin film 2, which transmits visible light, into close contact with the substrate 1; irradiating the thin film pattern forming region 11 on the substrate 1 with laser light L, thereby forming an opening pattern 21 having the same shape as the thin film pattern 14 in the film 2; forming the thin film pattern 14 in the thin film pattern forming region 11 on the substrate 1 through the opening pattern 21 of the film 2; and peeling off the film 2.

### CROSS-REFERENCE TO RELATED APPLICATION

This application is a continuation application of PCT/JP2013/058543, filed on Mar. 25, 2013, which is hereby incorporated by reference in its entirety for all purposes.

### BACKGROUND

1. Field

The present disclosure relates to a method for forming a thin film pattern on a surface of a substrate having an electrode formed in advance in a thin film pattern forming region, and in particular, relates to a method for forming a thin film pattern that can be used to easily form a high-definition thin film pattern.

2. Description of Background

As a conventional method for forming a thin film pattern, a mask having an opening or openings having a shape corresponding to a predetermined pattern is aligned with and then brought into close contact with a substrate to perform patterning film formation on the substrate through the mask (for example, see Japanese Patent Application Laid-open Publication No. 2003-73804).

In the conventional method for forming a thin film pattern, the mask to be used is usually prepared by forming an opening or openings having a predetermined shape in a thin metal plate by etching or the like. In such a metal mask, when a pitch of the openings is made narrow to form a high-definition thin film pattern, the pitch portion has reduced structural resistance and twisting may occur. When the mask twists, the mask may not be accurately aligned with the pattern on the substrate, and thus it becomes difficult to form a high-definition thin film pattern.

### SUMMARY

In one or more aspects, the subject disclosure provides methods to deal with such problems and provides a method for forming a thin film pattern to be able to easily form a high-definition thin film pattern.

A method for forming a thin film pattern according to one or more aspects of the subject disclosure is a method for forming a thin film pattern having a predetermined shape on a surface of a substrate having an electrode formed in advance in a thin film pattern forming region, including the steps of: bringing a resin film, which transmits visible light, into close contact with the substrate; irradiating the thin film pattern forming region on the substrate with laser light, thereby forming an opening pattern having the same shape as the thin film pattern in the film; forming the thin film pattern in the thin film pattern forming region on the substrate through the opening pattern of the film; and peeling off the film.

According to one or more aspects of the method for forming a thin film pattern of the subject technology, the opening pattern of the film is formed by laser light irradiation in a state in which the film is brought into close contact with the surface of the substrate. Accordingly, it is possible to form the opening pattern with high accuracy. The thin film pattern is formed through the opening pattern formed with high accuracy. Accordingly, it is possible to easily form the high-definition thin film pattern.

### BRIEF DESCRIPTION OF THE DRAWINGS

FIGS. 1A to 1I are explanatory views for illustrating an embodiment of a method for manufacturing an organic EL display device to which a method for forming a thin film pattern according to one or more aspects of the subject technology is applied, each of which is a cross-sectional view illustrating a TFT substrate in a red (R) organic EL layer forming process.

FIGS. 2A to 2I are cross-sectional views illustrating the TFT substrate in a green (G) organic EL layer forming process of the embodiment.

FIGS. 3A to 3I are cross-sectional views illustrating the TFT substrate in a blue (B) organic EL layer forming process of the embodiment.

FIGS. 4A to 4D are cross-sectional views illustrating the TFT substrate in a cathode electrode forming process of the embodiment.

FIG. 5 is a flowchart illustrating the R-organic EL layer forming process.

FIG. 6 is a flowchart illustrating the G-organic EL layer forming process.

FIG. 7 is a flowchart illustrating the B-organic EL layer forming process.

FIG. 8 is a flowchart illustrating the cathode electrode forming process.

### DETAILED DESCRIPTION

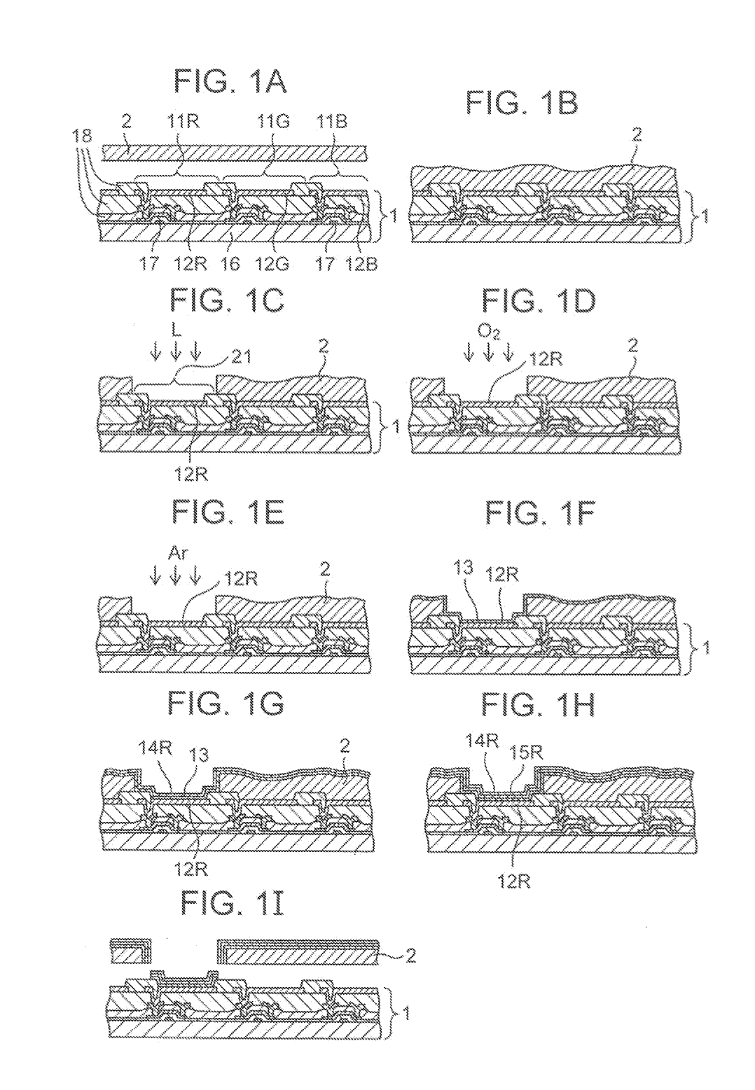

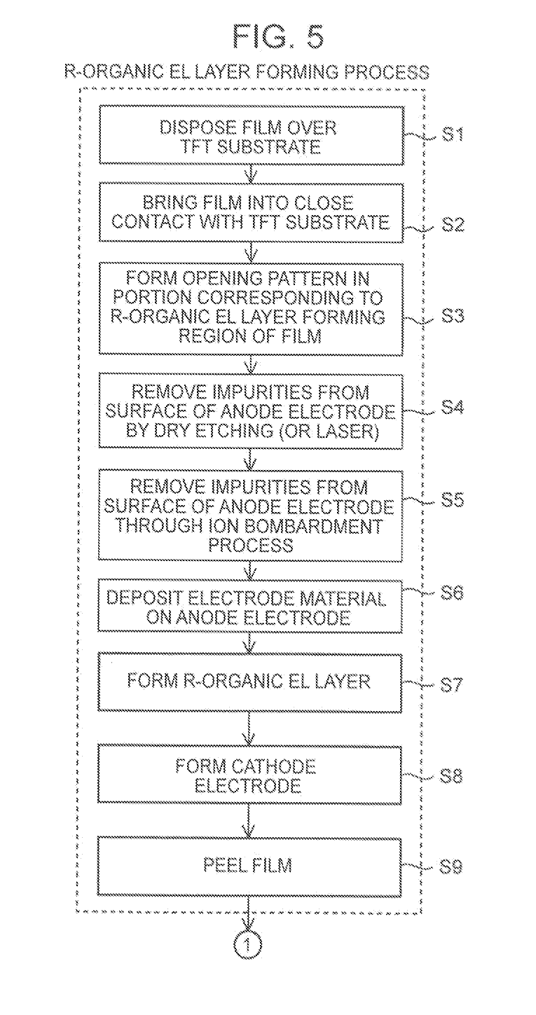

Hereinafter, an embodiment of a manufacturing method for manufacturing an organic EL display device by forming an organic EL layer on a substrate, to which a method for forming a thin film pattern according to one or more aspects of the subject technology is applied, will be described with reference to FIGS. 1 to 8. FIGS. 1 to 4 are cross-sectional views illustrating a TFT substrate 1 in a forming process of this embodiment, and FIGS. 5 to 8 are flowcharts illustrating the forming process of this embodiment. This organic EL display device manufacturing method is a method for manufacturing an organic EL display device by sequentially forming, on an anode electrode 12 (12R, 12G, 12B) formed in advance in an organic EL layer forming region (thin film pattern forming region) 11 (11R, 11G, 11B) of the TFT substrate 1, an organic EL layer (thin film pattern) 14 (14R, 14G, 14B) and a cathode electrode 15 (15R, 15G, 15B) having a predetermined shape, and includes a red (R) organic EL layer forming process, a green (G) organic EL layer forming process, a blue (B) organic EL layer forming process, and a cathode electrode forming process.

First, the R-organic EL layer forming process will be described with reference to FIGS. 1 and 5. This R-organic EL layer forming process is a process for forming the R-organic EL layer 14R by sequentially depositing and forming an electrode material 13 of the R-anode electrode 12R, the R-organic EL layer 14R, and the R-cathode electrode 15R in the R-organic EL layer forming region 11R of the TFT substrate 1, and includes Steps S1 to S9 as illustrated in FIG. 5.

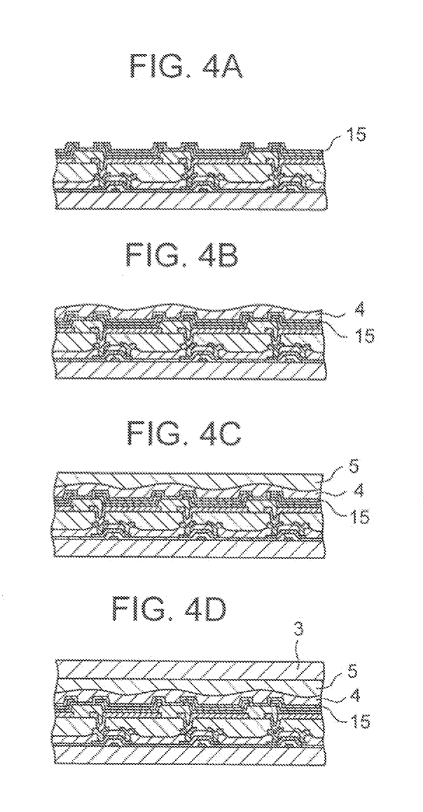

In Step S1, as illustrated in FIG. 1A, a film 2 is disposed over the TFT substrate 1. The TFT substrate 1 is formed by laminating, on a transparent substrate 16 made of glass or the like, a transistor 17, a plurality of insulating films 18, and the anode electrode 12 provided for each of the organic EL layer forming regions 11R, 11G, and 11B, and is driven by an active matrix driving system or a passive matrix driving system. Using this TFT substrate 1, an organic EL display device having a top emission system is manufactured. That is, in the organic EL display device to be manufactured in this embodiment, an image is displayed on the side of a counter substrate 3 to be described later (see FIG. 4D).

The film 2 is a resin film which transmits visible light. For example, a film which may be ablated by ultraviolet laser, such as polyethylene terephthalate (PET) or polyimide having a thickness of approximately 10 μm to approximately 30 μm, is used. This film 2 is held using, for example, a holding unit for holding the film 2 cut to have such a size as to cover the entire surface of the TFT substrate 1, or using a roller performing sending and winding of the long film 2, and is disposed over the TFT substrate 1 in FIG. 1A, that is, disposed separate from the R-anode electrode 12R of the TFT substrate 1.

In Step S2, as illustrated in FIG. 1B, the film 2 is brought into close contact with the TFT substrate 1. It is possible to bring the film 2 into close contact using a method such as electrostatic adsorption. This film 2 is transparent with respect to visible light. Accordingly, even when the film 2 covers the surface of the TFT substrate 1, an imaging unit such as a microscope or a CCD camera is able to observe the surface of the TFT through the film 2.

In Step S3, as illustrated in FIG. 1C, an opening pattern 21 is formed in a portion corresponding to the R-organic EL layer forming region 11R of the film 2. First, the imaging unit observes the surface of the TFT substrate 1 through the film 2 to detect a position of the R-organic EL layer forming region 11R on the TFT substrate 1. Next, a portion of the film 2 covering the surface of the detected R-organic EL layer forming region 11R is irradiated with laser light L. As the laser to be used herein, for example, an excimer laser or the like having a wavelength of 400 nm or less may be used, and for example, a KrF laser (248 nm) may be used. The film 2 is ablated and removed by optical energy of the ultraviolet laser light L, and thus the opening pattern 21 having the same shape as the R-organic EL layer forming region 11R is formed. From the opening pattern 21 of the film 2 formed as described above, the R-anode electrode 12R for driving the R-organic EL layer 14R (see FIG. 1G) of the TFT substrate 1 is exposed. In this case, the opening pattern 21 is preferably formed so that an insulating film disposed on both sides of the R-anode electrode 12R is partially exposed so as to be able to form the R-organic EL layer 14R over the entire surface of the R-anode electrode 12R.

In Step S4, as illustrated in FIG. 1D, impurities are removed from the surface of the R-anode electrode 12R. Herein, the impurities include, for example, residues of the film 2 ablated in the above-described Step S3 or the R-anode electrode 12R. When the R-organic EL layer 14R is formed in a state in which such impurities adhere to the surface of the R-anode electrode 12R, there are concerns that electric resistance of the R-anode electrode 12R may increase and problems may be caused in driving of the R-organic EL layer 14R. In addition, such impurities corrode the organic EL layer, and there is a concern that the service life of the organic EL layer may be reduced.

Etching or a laser is used to remove such impurities. When etching is performed, the impurities are preferably removed through dry etching using O₂ (oxygen), a mixture of O₂ and Ar (argon), a mixture of O₂, Ar, and CF₄ (carbon tetrafluoride), or the like as etching gas. When a laser is used, a green laser having a wavelength of 532 nm and an energy density of approximately 0.5 J/cm², a 355 nm UV laser, a 266 nm DUV laser, or the like may be used. In this case, O₂, a mixture of O₂ and Ar, a mixture of O₂, Ar, and CF₄, O₃ (ozone), or the like is preferably used in combination as assist gas.

In Step S5, as illustrated in FIG. 1E, the impurities remaining on the R-anode electrode 12R are removed. In Step S4, the impurities including the residues of the film 2, the R-anode electrode 12R and the like are removed by etching or a laser, but there is a concern that the residues adhering to the surface of the R-anode electrode 12R to be subjected to deposition may not be completely removed. Accordingly, in addition to Step S4, an ion bombardment process using inert gas plasma is performed to physically remove the impurities remaining on the R-anode electrode 12R. Thus, it is possible to turn on the organic EL without a reduction in the service life of the organic EL layer. Here, the inert gas includes Ar (argon), He (helium), Ne (neon), Xe (xenon), Kr (krypton), or the like.

In the above description, both of Steps S4 and S5 for removal of impurities are performed, but only one of Steps S4 and S5 may be performed. When the impurity removing process is not required after the end of the process of Step S3 in which the opening pattern 21 is formed, the above-described Steps S4 and S5, and Step S6, to be described later, may not be executed.

In Step S6, as illustrated in FIG. 1F, the electrode material 13 is deposited on the R-anode electrode 12R. Here, the electrode material 13 means a material for forming the anode electrode 12, and includes, for example, Al (aluminum), Mg (magnesium), or the like. The electrode material 13 is deposited to the surface of the R-anode electrode 12R through the opening pattern 21 formed in the film 2 using a method such as sputtering, vacuum deposition, and ion plating. When the residues of the impurities are completely removed in the above-described Step S4 or S5, the above-described Step S6 may not be executed.

In Step S7, as illustrated in FIG. 1G, the R-organic EL layer 14R is formed. The R-organic EL layer 14R is formed by sequentially depositing and laminating a hole injection layer, a hole transport layer, a red organic light-emitting layer, an electron transport layer, and the like through the opening pattern 21 of the film 2 on the R-anode electrode 12R.

In Step S8, as illustrated in FIG. 1H, the R-cathode electrode 15R is formed. The R-cathode electrode (ITO) 15R is a transparent metal thin film made of indium tin oxide or the like. The R-cathode electrode 15R is formed on the R-organic EL layer 14R through the opening pattern 21 formed in the film 2.

In Step S9, as illustrated in FIG. 1I, the film 2 is peeled off. The film 2 brought into close contact with the surface of the TFT substrate 1 is peeled off from the surface of the TFT substrate 1 by relatively separating the film 2 and the TFT substrate 1 in the vertical direction of FIG. 1. Thus, the R-organic EL layer forming process ends.

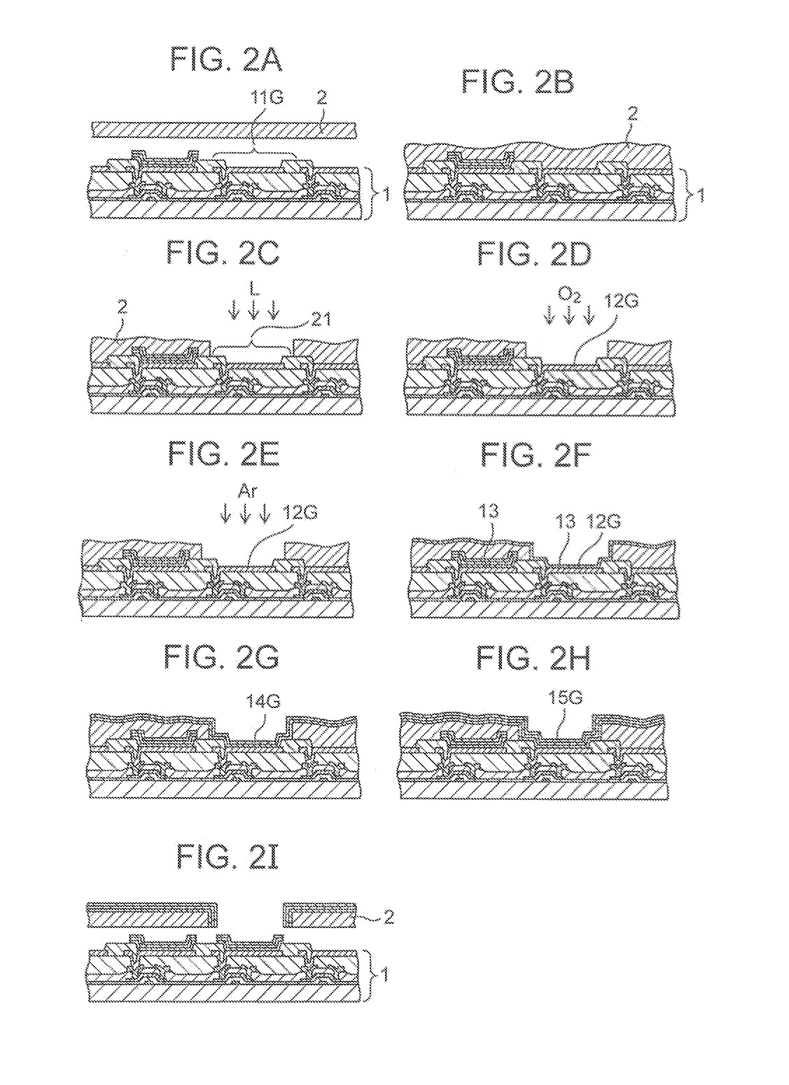

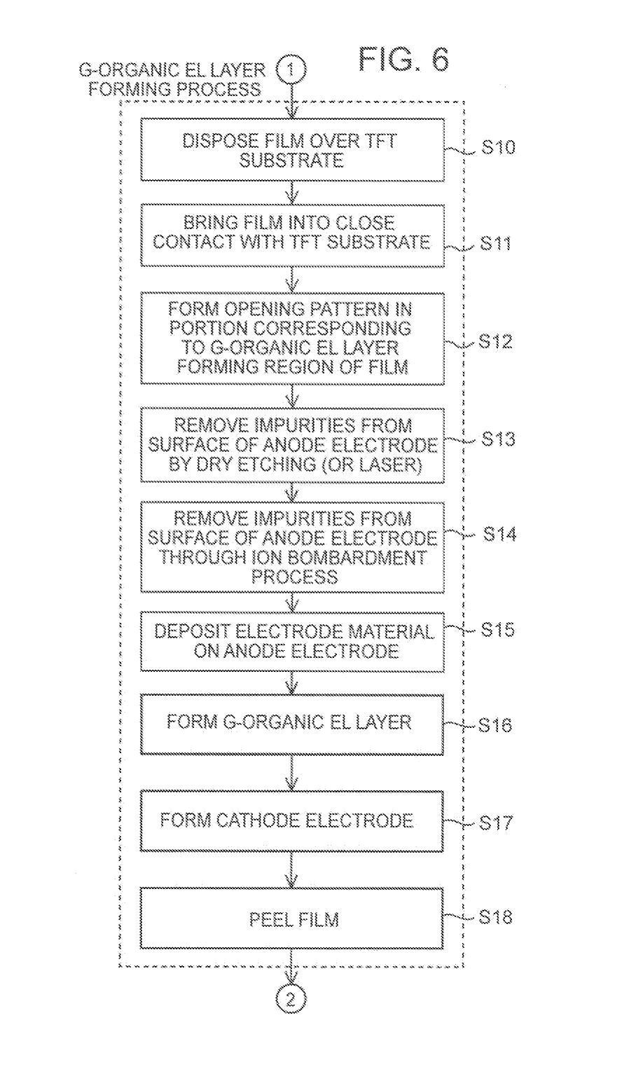

Next, the G-organic EL layer forming process will be described with reference to FIGS. 2 and 6. This G-organic EL layer forming process is a process for forming the G-organic EL layer 14G by sequentially depositing and forming an electrode material 13 of the G-anode electrode 12G, the G-organic EL layer 14G, and the G-cathode electrode 15G in the G-organic EL layer forming region 11G of the TFT substrate 1, and includes Steps S10 to S18 as illustrated in FIG. 6.

That is, a film 2 is disposed over the TFT substrate 1 in Step S10 (see FIG. 2A). The film 2 is brought into close contact with the TFT substrate 1 in Step S11 (see FIG. 2B), and an opening pattern 21 is formed in a portion corresponding to the G-organic EL layer forming region 11G of the film 2 in Step S12 (see FIG. 2C). Impurities are removed from a surface of the G-anode electrode 12G by dry etching (or a laser) in Step S13 (see FIG. 2D), and in Step S14, the impurities on the G-anode electrode 12G which have not been completely removed in Step S13 are removed through an ion bombardment process (see FIG. 2E). The electrode material 13 is deposited on the G-anode electrode 12G in Step S15 (see FIG. 2F), the G-organic EL layer 14G is formed in Step S16 (see FIG. 2G), the G-cathode electrode 15G is formed in Step S17 (see FIG. 2H), the film 2 is peeled off in Step S18 (see FIG. 2I), and the G-organic EL layer forming process ends.

In the above description, both of Steps S13 and S14 for removal of impurities are performed, but only one of Steps S13 and S14 may be performed. When the impurity removing process is not required after the end of the process of Step S12 in which the opening pattern 21 is formed, the above-described Steps S13, S14 and Step S15 may not be executed. When the residues of the impurities are completely removed in the above-described Step S13 or S14, the above-described Step S15 may not be executed.

The foregoing respective processes are the same as the corresponding processes of the R-organic EL layer forming process. The opening pattern 21 formed in the film 2 in Step S12 is formed so that a short circuit does not occur between the R-anode electrode 12R and the G-anode electrode 12G. That is, the respective opening patterns 21 are formed so that the electrode materials 13 deposited in the R-organic EL layer forming region 11R and the G-organic EL layer forming region 11G are not brought into contact with each other and separated from each other at a predetermined distance (see FIG. 2F).

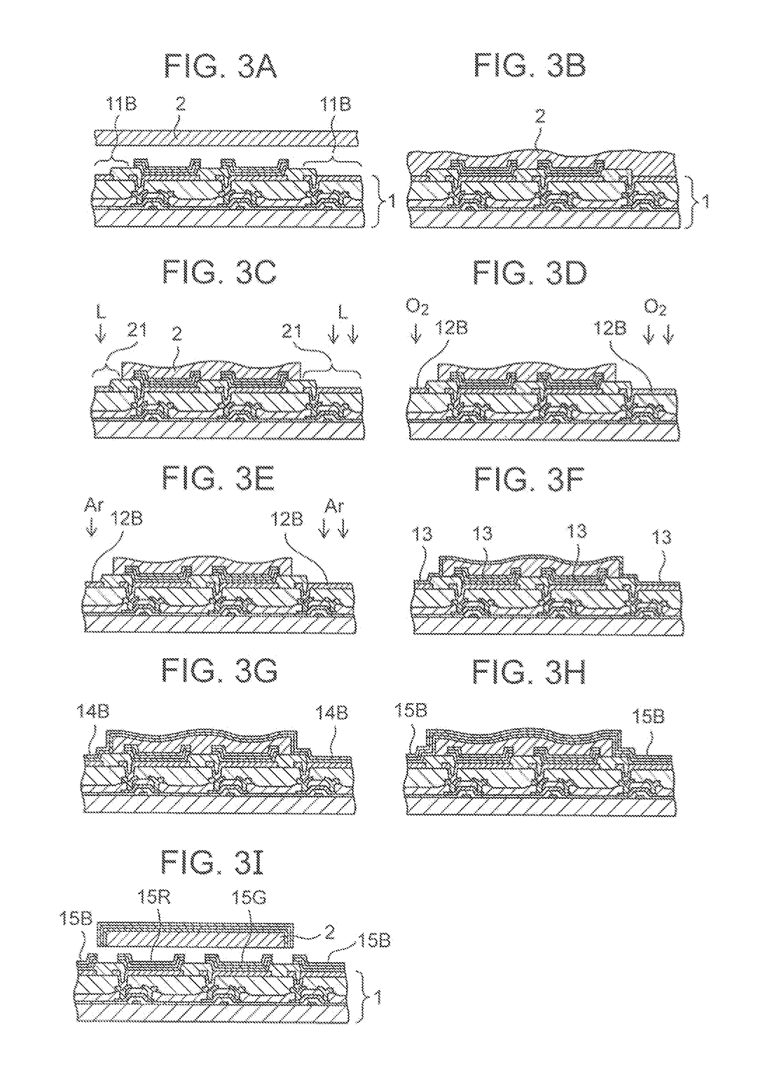

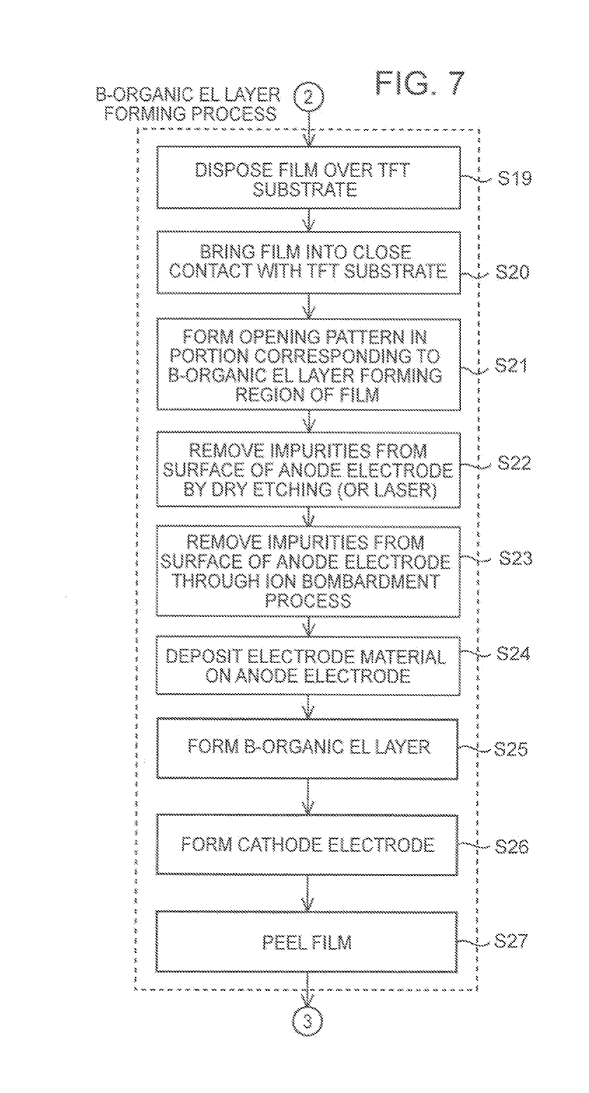

Next, the B-organic EL layer forming process will be described with reference to FIGS. 3 and 7. This B-organic EL layer forming process is a process for forming the B-organic EL layer 14B by sequentially depositing and forming an electrode material 13 of the B-anode electrode 12B, the B-organic EL layer 14B, and the B-cathode electrode 15B in the B-organic EL layer forming region 11B of the TFT substrate 1, and includes Steps S19 to S27 as illustrated in FIG. 7.

That is, a film 2 is disposed over the TFT substrate 1 in Step S19 (see FIG. 3A). The film 2 is brought into close contact with the TFT substrate 1 in Step S20 (see FIG. 3B), and an opening pattern 21 is formed in a portion corresponding to the B-organic EL layer forming region 11B of the film 2 in Step S21 (see FIG. 3C). Impurities are removed from a surface of the B-anode electrode 12B by dry etching (or a laser) in Step S22 (see FIG. 3D), and in Step S23, the impurities on the B-anode electrode 12B which have not been completely removed in Step S22 are removed through an ion bombardment process (see FIG. 3E). The electrode material 13 is deposited on the B-anode electrode 12B in Step S24 (see FIG. 3F), the B-organic EL layer 14B is formed in Step S25 (see FIG. 3G), the B-cathode electrode 15B is formed in Step S26 (see FIG. 3H), the film 2 is peeled off in Step S27 (see FIG. 3I), and the B-organic EL layer forming process ends.

In the above description, both of Steps S22 and S23 for removal of impurities are performed, but only one of Steps S22 and S23 may be performed. When the impurity removing process is not required after the end of the process of Step S21 in which the opening pattern 21 is formed, the above-described Steps S22, S23 and Step S24 may not be executed. When the residues of the impurities are completely removed in the above-described Step S22 or S23, the above-described Step S24 may not be executed.

The foregoing respective processes are the same as the corresponding processes of the R-organic EL layer forming process and the G-organic EL layer forming process. The opening pattern 21 formed in the film 2 in Step S21 is formed so that a short circuit does not occur among the R-anode electrode 12R, the G-anode electrode 12G, and the B-anode electrode 12B. That is, the respective opening patterns 21 are formed so that the electrode materials 13 deposited in the R-organic EL layer forming region 11R, the G-organic EL layer forming region 11G, and the B-organic EL layer forming region 11B are not brought into contact with each other and are separated from each other at a predetermined distance (see FIG. 3F).

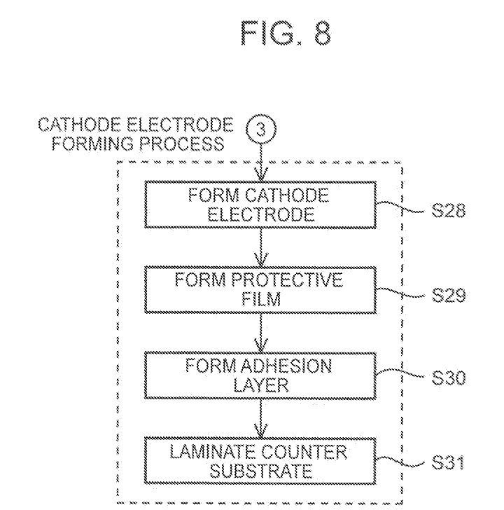

Finally, the cathode electrode forming process will be described with reference to FIGS. 4 and 8. This cathode electrode forming process is a process for completing an organic EL display device by forming the cathode electrode 15, and by then laminating the counter substrate 3, and includes Steps S28 to S31 as illustrated in FIG. 8.

In Step S28, as illustrated in FIG. 4A, the cathode electrode 15 is formed. In the above-described respective organic EL layer forming processes, the cathode electrodes 15R, 15G, and 15B are respectively formed on the organic EL layers 14R, 14G, and 14B, but these cathode electrodes 15R, 15G, and 15B are not electrically connected to each other (see FIG. 3I). Accordingly, an additional cathode electrode 15 is formed over the entire TFT substrate 1, to electrically connect the cathode electrodes 15R, 15G, and 15B to each other.

In Step S29, as illustrated in FIG. 4B, a protective film 4 is formed. This protective film 4 is made of an insulating material, and is formed on the cathode electrode 15 formed in the above-described Step S28 to completely cover the cathode electrode 15.

In Step S30, as illustrated in FIG. 4C, an adhesion layer 5 is formed on the protective film 4. The adhesion layer 5 is formed by, for example, spin coating or spraying of a UV-curable resin.

In Step S31, as illustrated in FIG. 4D, the counter substrate 3 is laminated. This counter substrate 3 is transparent and is laminated to the adhesion layer 5. It is possible to laminate the counter substrate 3 by, for example, bringing the counter substrate 3 into close contact with the adhesion layer 5, and by then curing the adhesion layer 5 by ultraviolet irradiation from the side of the counter substrate 3. Thus, the organic EL display device is completed.

According to this embodiment, the method for manufacturing an organic EL display device includes a step (S2, S11, S20) of bringing the resin film 2, which transmits visible light, into close contact with the TFT substrate 1, a step (S3, S12, S21) of irradiating the organic EL layer forming region 11 on the TFT substrate 1 with laser light L to form the opening pattern 21 having the same shape as the organic EL layer forming region 11 in the film 2, a step (S7, S16, S25) of forming the organic EL layer 14 in the organic EL layer forming region 11 on the TFT substrate 1 through the opening pattern 21 of the film 2, and a step (S9, S18, S27) of peeling off the film 2. The opening pattern 21 of the film 2 is formed by irradiation with the laser light L in a state in which the film 2 is brought into close contact with the surface of the TFT substrate 1. Accordingly, it is possible to form the opening pattern 21 with high accuracy. In addition, the organic EL layer is formed through the opening pattern 21 formed with high accuracy. Accordingly, it is possible to easily form the high-definition organic EL layer 14.

In addition, according to this embodiment, the method for manufacturing an organic EL display device further includes a step of removing impurities from the surface of the anode electrode 12 between the step (S3, S12, S21) of forming the opening pattern 21 in the TFT substrate 1 having the anode electrode 12 formed in advance in the organic EL layer forming region 11 and the step (S7, S16, S25) of forming the organic EL layer 14. In this case, a step (S4, S13, S22) of removing impurities from the surface of the anode electrode 12 by dry etching (or a laser) is performed. Accordingly, it is possible to reduce adverse effects such as an increase in electric resistance of the anode electrode 12 and corrosion of the organic EL layer 14, which are caused due to the impurities present on the anode electrode 12. In addition, a step (S5, S14, S23) of removing impurities from the surface of the anode electrode 12 through an ion bombardment process using inert gas is performed after the above-described step (S4, S13, S22). Accordingly, even when the impurities are not completely removed from the surface of the anode electrode 12 in the step (S4, S13, S22), the impurities are physically removed through the ion bombardment process, and thus it is possible to reduce adverse effects such as an increase in electric resistance of the anode electrode 12 and corrosion of the organic EL layer 14. Accordingly, it is possible to turn on the organic EL without a reduction in the life of the organic EL display device.

Furthermore, according to this embodiment, the method for manufacturing an organic EL display device further includes a step of depositing the electrode material 13 on the anode electrode 12 through the opening pattern 21 of the film 2 between the step (S3, S12, S21) of forming the opening pattern 21 in the TFT substrate 1 having the anode electrode 12 formed in advance in the organic EL layer forming region 11 and the step (S7, S16, S25) of forming the organic EL layer 14. In this case, a step (S6, S15, S24) of depositing the electrode material 13 on the anode electrode 12 through the opening pattern 21 of the film 2 is performed between the step (S4, S5; S13, S14; S22, S23) of removing impurities from the surface of the anode electrode 12 and the step (S7, S16, S25) of forming the organic EL layer 14. Accordingly, even when impurities adhere to the anode electrode 12 after the formation of the opening pattern 21 in the film 2, it is possible to prevent an increase in electric resistance of the anode electrode 12 by depositing the electrode material 13 thereafter. In addition, since the electrode material 13 is deposited between the impurities and the organic EL layer 14, it is possible to prevent corrosion of the organic EL layer 14 due to the impurities.

Although the subject technology is applied to the method for manufacturing an organic EL display device described in this exemplary embodiment, the subject technology may also be applied to forming of organic EL display devices having a bottom emission system, forming of color filters of liquid crystal display devices, forming of wiring patterns of semiconductor substrates, and the like, so long as a high-definition thin film pattern is formed.

In another embodiment of the subject technology, a thin metal plate made of iron or the like may be disposed in at least a part of the upper portion of the film 2 (on the opposite side to the TFT substrate 1), and a magnetic chuck may be disposed below the TFT substrate 1 (on the opposite side to the film 2). Due to such a configuration, it is possible to bring the film 2 into close contact with the TFT substrate 1 by magnetic attraction.

In this embodiment, the additional cathode electrode 15 is formed over the entire TFT substrate 1 in the cathode electrode forming process after each cathode electrode is formed in each of the organic EL layer forming processes. However, the cathode electrode in each of the organic EL layer forming processes may be omitted.

It should be noted that the entire contents of Japanese Patent Applications No. 2012-079207, filed on Mar. 30, 2012, and No. 2012-264451, filed on Dec. 3, 2012, on which convention priorities are claimed, are incorporated herein by reference.

It should also be understood that many modifications and variations of the described embodiments of the subject technology will be apparent to a person having an ordinary skill in the art without departing from the spirit and scope of the present invention as claimed in the appended claims.

What is claimed is:

1. A method for forming a thin film pattern having a predetermined shape on a surface of a substrate having an electrode formed in advance in a thin film pattern forming region, the method comprising the steps of:
bringing a resin film, which transmits visible light, into close contact with the substrate;
irradiating the thin film pattern forming region on the substrate with laser light, thereby forming an opening pattern having the same shape as the thin film pattern in the film;
forming the thin film pattern in the thin film pattern forming region on the substrate through the opening pattern of the film; and
peeling off the film.

2. The method for forming a thin film pattern according to claim 1, further comprising the step of:
removing impurities from a surface of the electrode between the step of forming the opening pattern and the step of forming the thin film pattern.

3. The method for forming a thin film pattern according to claim 1, further comprising the step of:
depositing an electrode material on the electrode through the opening pattern of the film between the step of forming the opening pattern and the step of forming the thin film pattern.
